(19) United States
(12) Patent Application Publication
(10) Pub. No.: US 2025/0019280 A1
(43) Pub. Date: Jan. 16, 2025

(54) Water Treatment Systems Using Ozone-Filled Nanobubbles

(71) Applicant: NBOT Systems, LLC, Mount Pleasant, SC (US)

(72) Inventors: Brian C. DOMRESE, Charleston, SC (US); Steven GARELECK, Atlanta, GA (US)

(21) Appl. No.: 18/891,523

(22) Filed: Sep. 20, 2024

Related U.S. Application Data
(63) Continuation-in-part of application No. 17/649,040, filed on Jan. 26, 2022.
Application No. 17/649,040 is a continuation of application No. 16/832,308, filed on Mar. 27, 2020, now Pat. No. 11,247,923.
(60) Provisional application No. 62/825,491, filed on Mar. 28, 2019.
(60) Provisional application No. 62/969,729, filed on Feb. 4, 2020.

(51) Int. Cl. C02F 1/78; B01F 23/232; B01F 23/237; B01F 23/2375; B01F 25/312; B01F 25/51; B01F 25/53; B01F 101/00; C02F 101/30

(52) U.S. Cl. CPC C02F 1/78; B01F 23/2323; B01F 23/2375; B01F 25/3121; B01F 25/51; B01F 25/53; B01F 23/237613; B01F 2101/305; C02F 2101/30; C02F 2201/005; C02F 2201/782; C02F 2201/784; C02F 2301/046; C02F 2303/04

(57) ABSTRACT

Water treatment systems and methods are described herein for optimizing the formation and delivery of ozone-filled nanobubbles for disinfecting a volume of water. In an example system for treating water in a pool, such as a swimming pool, a control valve located downstream relative to a pool pump draws a select volume of water into through a circuit of elements including a pump assembly, a Venturi assembly for injecting a supply of ozone-rich gas into the water, a pressure vessel, and a nozzle assembly for generating a variable concentration of ozone-filled nanobubbles in the water. The ozone-filled nanobubbles in the pool water are stable, safe and odorless, and far more effective than chlorine or ozone alone. With the ozone-filled nanobubbles in the water column, the measurable concentration of dissolved ozone in the water is remarkably steady under a variety of operating conditions.

### CROSS REFERENCE TO RELATED APPLICATIONS

The present application is a continuation-in-part of U.S. application Ser. No. 17/649,040, filed on Jan. 26, 2022, and entitled, “Gas Injection Systems For Optimizing Nanobubble Formation In A Disinfecting Solution,” which is a continuation of U.S. application Ser. No. 16/832,308 (now U.S. Pat. No. 11,247,923), which claims the benefit of and priority to both U.S. Provisional Application 62/825,491, filed Mar. 28, 2019, entitled “Backflow Device for Optimizing the Formation of Nano-bubbles in a Fluid,” and U.S. Provisional Application 62/969,729, filed Feb. 4, 2020, entitled “Systems and Methods of Infusing Nano-bubbles of Enriched Gas into a Fluid to Create a Solution for Removing Pollutants,” the entire contents of all of which are incorporated herein by reference.

### TECHNICAL FIELD

Examples set forth in the present disclosure relate to the field of air and water treatment systems. More particularly, but not by way of limitation, the present disclosure describes methods and systems for optimizing the formation of gas nanobubbles in a disinfecting solution.

### BACKGROUND

Conventional water treatment systems use a variety of chemicals, most of which are not environmentally friendly, to remove microbial toxins and pathogens. Treating large bodies of open water such as lakes, ponds, and livestock waste pools is currently too expensive and not technologically feasible. Untreated waste often includes large amounts of methane, nitrogen, and other substances that raise concerns about environmental impact. Ballast water released from cargo ships can contaminate bays and inlets around ports. Concern is also increasing about the threat of terrorist activity that might be directed toward the water supply, as well as natural water sources and environments. Existing systems for disinfecting and sterilizing the air in a room, surfaces, medical equipment, and other components are expensive, time-consuming, and in many cases are not fully effective. Many types of microbes and pathogens, including viruses, can survive on surfaces and in enclosed spaces for a lengthy period of time unless treated.

### BRIEF DESCRIPTION OF THE DRAWINGS

Features of the various implementations disclosed will be readily understood from the following detailed description, in which reference is made to the appending drawing figures. A reference numeral is used with each element in the description and throughout the several views of the drawing. When a plurality of similar elements is present, a single reference numeral may be assigned to like elements, with an added lower-case letter referring to a specific element.

The various elements shown in the figures are not drawn to scale unless otherwise indicated. The dimensions of the various elements may be enlarged or reduced in the interest of clarity. The several figures depict one or more implementations and are presented by way of example only and should not be construed as limiting. Included in the drawing are the following figures:

FIG. 1 is a schematic illustration of a gas-injection system, according to an example implementation;

FIG. 2A is a schematic view of a pressure vessel suitable for use with the gas-injection system of FIG. 1;

FIG. 2B is a perspective illustration of a deflector, according to some example implementations;

FIG. 3A is an illustration of a backflow valve assembly with a manual control, according to some example implementations;

FIG. 3B is an illustration of a backflow valve assembly with motorized control, according to some example implementations;

FIG. 4 is an illustration of a nozzle, according to some example implementations;

FIG. 5 is a schematic illustration of a water treatment system, according to an example implementation;

FIG. 6 is a schematic illustration of a water treatment system, according to another example implementation; and

FIG. 7 is a schematic illustration of a water treatment system, according to yet another example implementation.

### DETAILED DESCRIPTION

The present systems and apparatuses and methods are understood more readily by reference to the following detailed description, examples, and drawings. The terminology used herein is for the purpose of describing particular aspects only and is not intended to be limiting.

Like parts are marked throughout the following description and drawings with the same reference numerals. The drawings may not be to-scale and certain features may be shown exaggerated in scale or in somewhat schematic format in the interest of clarity, conciseness, and to convey information.

The following description is provided as an enabling teaching in its currently known embodiment. To this end, those skilled in the relevant art will recognize and appreciate that many changes can be made to the various aspects described herein, while still obtaining the beneficial results. It will also be apparent that some of the desired benefits can be obtained by selecting some of the features described without utilizing others. Accordingly, those who work in the art will recognize that many modifications and adaptations to the examples described are possible and can even be desirable in certain circumstances and are a part of this disclosure. Thus, the following description is provided as illustrative of the principles and not in limitation.

As used throughout, the singular forms “a,” “an” and “the” include plural referents unless the context clearly dictates otherwise. Thus, for example, reference to a component can include two or more such components unless the context indicates otherwise.

Ranges can be expressed herein as from “about” one particular value and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

As used herein, the term “facilitate” means to aid, assist, or make easier. The term “inhibit” means to impede, interfere with, hinder, or delay the progress.

As used herein, the terms “proximal” and “distal” are used to describe items or portions of items that are situated closer to and away from, respectively, another item or a user. Thus, for example, the far end of a pipe attached to a vessel may be referred to as the distal end because it is far away relative to the vessel.

The terms “coupled” or “connected” as used herein refer to any logical, optical, physical, or electrical connection, including a link or the like by which the electrical or magnetic signals produced or supplied by one system element are imparted to another coupled or connected system element. Unless described otherwise, coupled or connected elements or devices are not necessarily directly connected to one another and may be separated by intermediate components, elements, or communication media, one or more of which may modify, manipulate, or carry the electrical signals.

The term “nanobubble” as used herein refers to and includes bubble diameters between about ten nanometers and about four hundred microns. A nanometer is one billionth of a meter (1.0E-9 meter). A micron or micrometer equals one millionth of a meter (1.0E-6 meter).

A solution is a liquid mixture in which a minor component, called a solute (such as an enriched gas) is dissolved into a major component, called the solvent (such as water, for aqueous solutions). The quantity of solute that can be dissolved into a solvent varies, depending on several factors such as temperature and the solubility of the solute. The capacity of a solute to be dissolved in a solvent is known as solubility. Solubility is a chemical property of the solute and does not change.

A solution is saturated when it contains the largest possible quantity of the solute (such as enriched gas) that can be dissolved into the solvent under normal conditions. Special conditions, such as kinetic mixing, injection at higher pressures, higher temperatures, and/or for long durations, are typically required in order to inject additional solute into the solvent. The forced addition of more solute, in some cases, produces a solution. A solution of gases in a liquid will typically form bubbles. Carbonated water is an example of an aqueous solution supersaturated with carbon dioxide gas.

The term “injected” as used herein means and refers to the forced injection of additional gas (solute) into the fluid (solvent) which, under some conditions, produces a supersaturated solution. The term “released” as used herein refers to the opposite process, during which gas bubbles that were once dissolved in a fluid solution are un-dissolved or released.

Additional objects, advantages and novel features of the examples will be set forth in part in the following description, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

Although the various embodiments and implementations are described with reference to an example system for optimizing bubble size and concentration in a fluid mixture to improve its usefulness in decontamination applications, the systems and methods described herein may be applied to and used with any of a variety of other systems.

Reference now is made in detail to the examples illustrated in the accompanying drawings and discussed below.

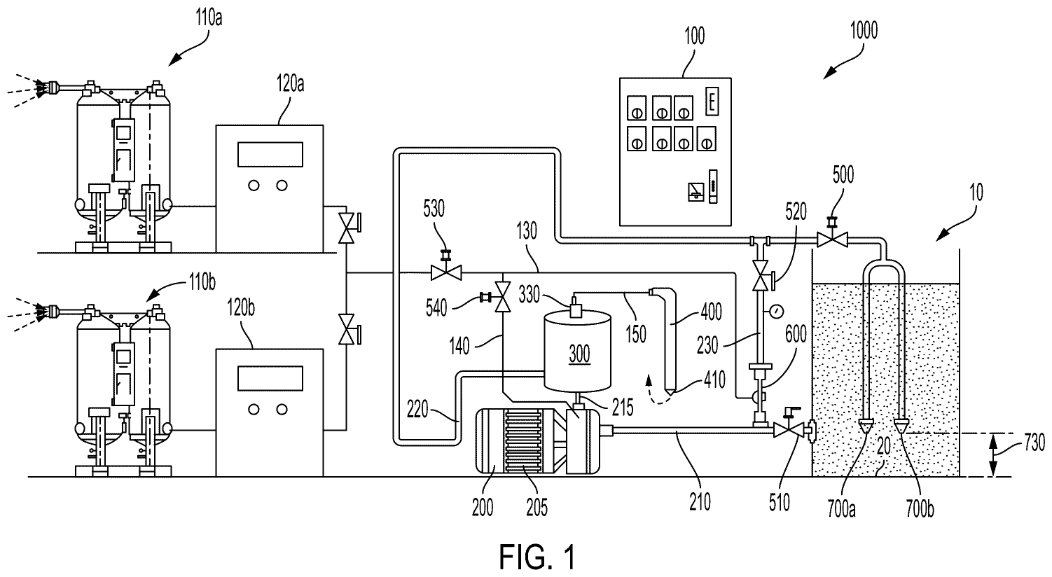

FIG. 1 is a schematic illustration of a gas-injection system 1000, according to an example implementation. The system 1000 includes a centrifugal pump 200 for circulating a in and through a circuit of elements, wherein each element is in fluid communication with the next. The circuit of elements, in this example, includes the centrifugal pump 200, a pressure vessel 300, a backflow valve 500, a Venturi injector 600, and a pair of nozzles 700a, 700b immersed in the reservoir 10 of contaminated fluid. The contaminated fluid may be water, saltwater, another liquid, or a gas in fluid state, such as air. The circuit of elements is monitored, adjusted, and controlled by a control unit 100, as described herein. The circuit of elements is closed, recirculating the fluid for treatment until a desired quantity of pollutants is removed from the fluid. The term pollutant is used herein in its broadest sense, to include any of a variety of substances to be removed from the fluid.

The system 1000 also includes a gas supply, which may supply one or more gases (e.g., ozone, oxygen, hydrogen). The gas supply, in some implementations, includes one or more oxygen concentrators 110a, 110b for converting ambient air into an oxygen-enriched gas. Some types of oxygen concentrators can process about thirty liters per minute and generate an oxygen enrichment of about ninety-two percent. Larger concentrators and other equipment can be used to scale-up the system that handle larger volumes of fluids and gases. The gas supply also includes one or more ozone generators 120a, 120b for converting the oxygen-enriched gas into an ozone-rich gas. The ozone-rich gas enters the circuit of elements at the pump 200 and at the Venturi injector 600. The system 1000 also includes an ozone destructor 400 for capturing excess ozone and converting it to oxygen. In other example implementations, one or more different gases may be used. For example, the system may first infuse an ozone-rich gas to clean a reservoir of water, followed by an injection of oxygen-rich gas to remove any excess ozone, followed by an injection of additional oxygen and/or hydrogen to increase the concentrations of such gases in the water and thereby create a drinking water that is infused with such gases.

The centrifugal pump 200 includes a mixing chamber 205 where the contaminated fluid mixes with a gas (e.g., an ozone-rich gas). The centrifugal pump 200 includes one or more drive rotors called impellers inside the mixing chamber 205 to promote mixing and facilitate the injection of gas into the fluid. In a centrifugal pump 200, the fluid enters the mixing chamber 205 near the center of the rapidly rotating impellers, which force the fluid by centrifugal force outwardly (i.e.; radially, relative to the center of the impellers). In an alternative implementation, the mixing chamber 205 includes one or more gears, pairs of gears, or other agitators to promoting mixing. The gas enters the mixing chamber 205 under relatively high pressure, causing the gas to dissolve in the fluid, which causes bubbles to form. Controlling the volumes and pressures of fluid and gas facilitates the formation of smaller and smaller bubbles, some of which are nanobubbles. The gas supply, as shown, injects a first quantity of gas into the fluid, inside the mixing chamber 205, to produce a first solution. The first solution may or may not be fully saturated with gas. The first solution contains a first volume of gas nanobubbles.

The gas flows to the pump 200 through a gas inlet tube 140, which may include a first control valve 540. The contaminated fluid flows to the pump 200 through an inlet pipe 210, which may include an inlet valve 510 for controlling the flow from the reservoir 10. The inlet valve 510 also prevents fluid from draining out of the reservoir 10 when the system 1000 is not in use. The inlet pipe 210 may also include a priming pump (not shown) for initiating the flow of fluid into the circuit, which is particularly useful when the system starts to operate. The inlet pipe 210 and other pipes carrying the fluid may be made of PVC, flexible hose, or another suitable material capable of withstanding the pressures and temperatures of the system 1000.

The pressure vessel 300 is mounted above the pump 200 in this example. The pressure vessel 300 is configured to receive the first solution from the pump 200, and hold the first solution under an internal pressure, and for a selected duration. The pressure and duration are set, adjusted, and controlled by the control unit 100. The combination of pressure and time facilitates the additional injection of gas nanobubbles—both inside the pressure vessel 300 and inside the mixing chamber 205, due to the backflow pressure generated by the pressure vessel 300. The combination of pressure and time produces a second solution, which contains a second volume of gas nanobubbles (in addition to the first volume injected inside the mixing chamber 205 of the pump 200.

The second solution, in some implementations, exits the pressure vessel 300 and flows through the outlet pipe 220 to a pair of nozzles 700a, 700b which are configured to spray the second solution into the reservoir 10. As shown in FIG. 1, the Y-shaped splitter pipe may be symmetrical in order to evenly divert the flow into the pair of nozzles 700a, 700b. Like the pressure vessel 300, the nozzles 700a, 700b generate a backflow pressure into the system, which facilitates the additional injection of nanobubbles in the elements located upstream. The nozzles 700a, 700b are spaced apart from one another and immersed in the reservoir 10 to a depth located at a mean height 730 above the reservoir floor 20. The nozzles 700a, 700b, in some implementations, are suspended above the reservoir floor 20 by one or more floats and counterweights (not shown), especially in environments subject to tidal changes or other volume-related fluctuations. The nozzles 700a, 700b are sized and shaped to release a portion of the volumes of gas nanobubbles into the fluid in the reservoir 10. The release of the nanobubbles injects the gases that were dissolved in the second solution. For implementations in which the gas is an ozone-rich gas, the release of nanobubbles creates hydroxyl radicals which are highly reactive and useful in destroying organic compounds and other contaminants.

The second solution, in another example implementation, exits the pressure vessel 300 and flows through an outlet pipe 220 to a backflow valve 500 before flowing into the nozzles 700a, 700b. The backflow valve 500 is positioned within the outlet pipe 220 and is constructed and otherwise configured to selectively restrict the flow of the second solution through the outlet pipe 220. By restricting the flow through the outlet pipe 220, the backflow valve 500 generates a significant backflow pressure in the system, which facilitates the additional injection of nanobubbles in the elements located upstream. The backflow pressure increases the internal pressure inside the pressure vessel 300 and prolongs the duration of time for mixing inside the pressure vessel 300. The backflow pressure, to some extent, also affects the pressure and mixing time inside the mixing chamber 205 of the pump 200. The combination of increased pressure and a longer mixing time causes the pressure vessel 300 to produce a third solution, which contains a third volume of gas nanobubbles (in addition to the first volume injected inside the mixing chamber 205 of the pump 200, and in addition to the second volume injected inside the pressure vessel 300 in a system that does not include a backflow valve). After passing through the backflow valve 500, the third solution is injected into the reservoir 10 through the nozzles 700a, 700b as described herein.

The system 1000 illustrated in FIG. 1 also includes a circuit for recirculating the solution back into the centrifugal pump 200. As shown, a recirculation pipe 230 is configured to deliver a selected portion of the solution from the outlet pipe 220 and back into the inlet pipe 210. The recirculation pipe 230 includes a recirculation valve 520 to control the flow; in other words, to control the selected portion of the solution to be recirculated. The recirculation pipe 230 includes a Venturi injector 600 which, as the name suggests, is sized and shaped to create the Venturi effect as the solution flows through it. The Venturi injector 600 includes a suction port in the side wall of the lengthwise chamber through which the solution flows. A supplemental gas inlet tube 130 is connected to the suction port and configured to carry the ozone-rich gas. The gas inlet tube 130, in some implementations, does not include a control valve, instead relying on the suction generated by the Venturi injector 600 to draw gas through the inlet tube 130. The gas valve 540 in the gas supply tube 140 to the pump 200 can be adjusted when the Venturi injector 600 is operating, in order to balance the supply of gas.

The lengthwise chamber is sized and shaped to create a pressure differential, which is sufficient to draw a supplemental quantity of gas through the suction port and into the selected portion of the solution. The injection of supplemental gas produces a fourth solution, which contains a fourth volume of gas nanobubbles (in addition to the first volume injected inside the mixing chamber 205 of the pump 200, and in addition to the second volume injected inside the pressure vessel 300). The fourth solution next flows into the main inlet pipe 210 and back into the centrifugal pump 200 for additional mixing and injection of additional gas.

The system 1000, in some implementations, may deliver the ozone-rich gas either (a) through the inlet tube 140 only, directly into the centrifugal pump 200, (b) through the supplemental gas inlet tube 130 only, directly into the Venturi injector 600, or (c) through both inlet tubes 140, 130—in which case the pump 200 and the Venturi injector 600 cooperate to improve the quality and quantity of nanobubbles in the solution.

The control unit 100 is connected and configured to set, monitor, adjust, and otherwise control the system 1000, as described herein, including the gas supply, the centrifugal pump 200, the pressure vessel 300, the backflow valve 500, the Venturi injector 600, and the oxygen destructor 400, as well as the valves located in the piping and tubing that connects the elements of the system 1000.

For example, the control unit 100, in some implementations, controls the oxygen concentrators 110a, 110b, the ozone generators 120a, 120b, and the gas valves 530, 540 that control the flow of gas in the system 1000. The control unit 100 controls the speed of the motor driving the pump 200, the internal pressure inside the pressure vessel 300, the backflow valve 500, and the Venturi injector 600, as well as the fluid valves 510, 520 that control flow of fluid in the system 1000.

By and through its connections to the system 1000, the control unit 100 also gathers and stores information about flow velocities, pressures, temperatures, and other conditions. By adjusting the valves and other elements in the system 1000, the control unit 100 balances the flow velocities, pressures, and temperatures between and among the system elements in order to optimize the generation of nanobubbles. In this aspect, adjustments to the system parameters made by the control unit 100 cause the system 1000 as a whole to generate a larger quantity and concentration of nanobubbles, a higher quality of nanobubbles, and a more stable solution at various stages throughout the circuit so that the nanobubbles are retained in solution until they reach the nozzles 700a, 700b.

The control unit 100, in some implementations, includes a programmable logic controller (PLC) that operates and controls a power supply, timers and counters, a processor (e.g., a CPU) connected to a memory (e.g., for storing programming and maintaining a log of temperatures and pressures), a plurality of input-output interfaces through which the PLC receives and sends data to and from external device, and a communications interface for sending and receiving data to and from remote devices, such as computers and mobile device (e.g., to facilitate remote control and remote access to the data and settings).

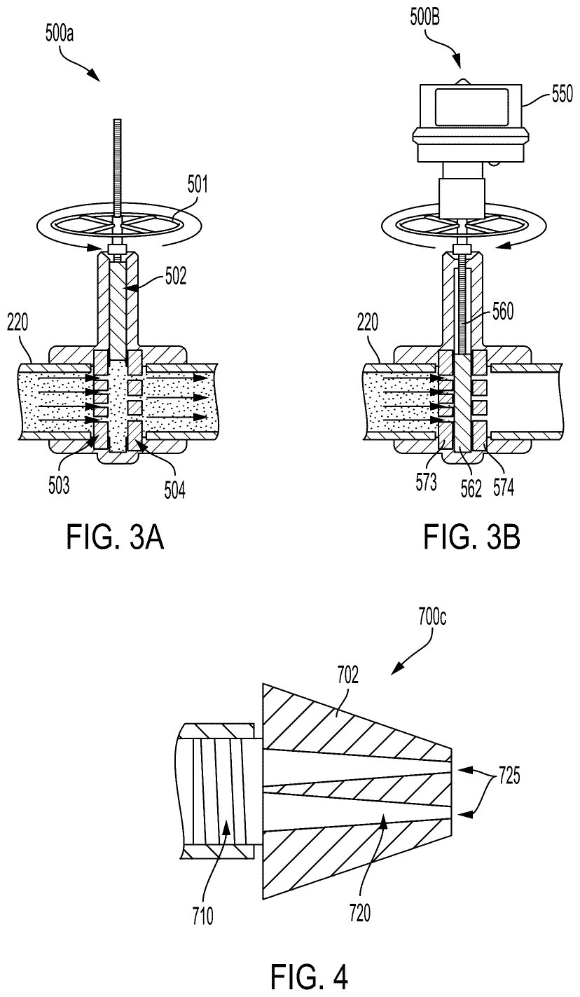

The PLC through its input-output interfaces is adapted to interact with external controllers, such as the motor 500 that controls the backflow valve assembly 500b (FIG. 3B) and the motors that control the settings on the gas valves and fluid valves. The control unit 100 and/or its PLC, in some implementations, includes a variable-frequency drive (VFD) for controlling the motor driving the pump 200, which is particularly useful during system startup and power-down.

The control unit 100 and/or its PLC may include one or more redundant or backup modules to prevent total or partial shutdown of the system 1000 due to hardware failure or power interruption. Emergency shutoff sequences and alarms may be activated in case of hardware failure, excess pressures or temperatures, or other types of system overloads.

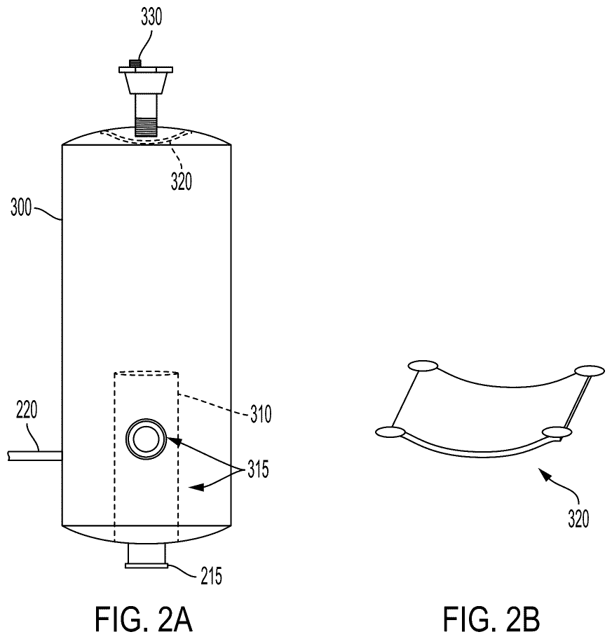

FIG. 2A is a schematic view of a pressure vessel 300 suitable for use with the example gas-injection systems described herein. The pressure vessel 300 receives a flow of the first solution from the pump 200 through a connecting pipe 215. At the bottom of the pressure vessel 300, the first solution flows through a diverter pipe 310, as shown. The diverter pipe 310 extends lengthwise, and in a substantially vertical orientation, from a base end at the bottom of the pressure vessel 300 to a distal end. The distal end of the diverter pipe 310 may be located near the center of the pressure vessel 300, to facilitate mixing. As shown, the side wall of the diverter pipe 310 includes a plurality of perforations 315. The first solution exits the pipe 310 through the perforations 315 and into the pressure vessel 300. The perforations 315 may be any of a variety of sizes and shapes designed to facilitate mixing and injection.

The pressure vessel 300 includes a vent 330 for releasing the excess volume of the ozone-rich gas. Instead of releasing this excess ozone-rich gas into the atmosphere, the excess volume travels through a vapor tube 150 into an ozone destructor 400, as shown in FIG. 1.

As shown in FIG. 2A, the pressure vessel 300 also includes a deflector 320. The deflector 320 is sized and shaped, and positioned, to selectively inhibit the incoming flow of the first solution from flowing into the vent 330. In this aspect, the deflector 320 prevents the incoming solution from spraying or otherwise flowing into the vent 330, which is designed to capture excess gas and not fluid. The fluid exits through the outlet pipe 220. The deflector 320 is also sized and shaped, and positioned, to selectively inhibit the flow of ozone-rich gas from entering the vent 330 too soon. The pressure vessel 300 is designed to hold the first solution, under pressure, for a selected duration, as described herein.

FIG. 2B is a perspective illustration of an example deflector 320, which is made from a metal plate, one-eighth inch thick and generally rectangular in shape. The example deflector 320 is a curved plate with its four corners welded to the ceiling or upper surfaces inside the pressure vessel 300 near the vent 330. The excess flow of ozone-rich gas, in this example, may flow around the side edges of the example deflector 320 and into the vent 330. The deflector 320, in some implementations, may be made from another material, formed into other shapes and sizes, and may include perforations or other openings to allow the excess flow of ozone-rich gas to enter the vent 330. The pressure inside the pressure vessel 300 is selected to facilitate additional mixing and injection. When the selected pressure is exceeded, the excess flow of ozone-rich gas will enter the vent 330.

Referring again to FIG. 1, the system 1000, in some implementations, includes an ozone destructor 400 for capturing an excess volume of the ozone-rich gas from the pressure vessel 300. This excess volume is characterized by its having not been infused into the first solution. The ozone destructor 400 includes a catalyst for converting substantially all the ozone in the excess volume to oxygen, and an outlet 401 for venting the oxygen (directly to the atmosphere, in some implementations). The catalyst may be a compound such as manganese dioxide, copper oxide, or other suitable compounds, or mixtures thereof. The ozone destructor 400, in various implementations, may include a heater, one or more vanes or other structures for directing the flow of gas through the chamber, filter media in addition to the catalyst, and a fan for drawing the gas through the chamber and/or expelling the oxygen through the outlet 401. For systems in which the gas is not an ozone-rich gas, the ozone destructor 400 may be replaced with another type of system for safely handling excess gas before it is released to the atmosphere.

FIG. 3A is a cross-sectional illustration of a backflow valve assembly 500a with a manual control, located in the outlet pipe 220. The backflow valve assembly 500a, in some implementations, includes a handle 501 configured to lower and raise a blade 502 into the pipe 220 to modify the flow of fluid therethrough and thereby generate a backflow pressure in the elements located upstream, as described herein. The blade 502 may be constructed of a solid stainless-steel plate having a thickness of between about one eighth and one quarter of an inch. The solid blade 502 is sized and shaped to fit between an upstream plate 503 and a downstream plate 504. The plates 503, 504 include one or more drilled holes or openings, as shown.

FIG. 3B is a cross-sectional illustration of a backflow valve assembly 500b with a motorized control, located in the outlet pipe 220. The backflow valve assembly 500b, in this example, includes a motor 550 connected to a shaft 560 that is configured to lower and raise a blade 560 into the pipe 220 to modify the flow of fluid therethrough and thereby generate a backflow pressure in the elements located upstream, as described herein. The blade 560 may be constructed of a solid stainless-steel plate having a thickness of between about one eighth and one quarter of an inch. The solid blade 560 is sized and shaped to fit between an upstream plate 573 and a downstream plate 574. The plates 573, 574 include one or more drilled holes or openings, as shown. The motor 550 may be connected to and controlled by the control unit 100 or controlled separately.

Whether manual or motorized, the backflow valve assembly 500a, 500b is adjustable, in some implementations, to generate a desired amount of backflow pressure in the elements located upstream. As the backflow valve assembly 500a, 500b is closed, the flow restriction increases, which in turn generates a higher backflow pressure. The backflow pressure increases the internal pressure inside the pressure vessel 300 and prolongs the duration of time for mixing inside the pressure vessel 300. The backflow pressure, to some extent, also affects the pressure and mixing time inside the mixing chamber 205 of the pump 200.

In another implementation, the backflow valve assembly 500 is not adjustable with a manual or motorized control. In this example, the backflow valve assembly 500 is custom-made and includes one or more internal components designed to restrict or modify the flow of fluid through the valve and to thereby generate a backflow pressure in the elements located upstream, as described herein.

FIG. 4 is an illustration of a nozzle assembly 700c according to some example implementations. The nozzle assembly 700c includes a threaded connector 710 configured to attach to the outlet pipe 220. Like the pressure vessel 300 and the backflow valve assembly 500, the nozzle assembly 700c generates a backflow pressure into the system, which facilitates the additional injection of nanobubbles in the elements located upstream. In this aspect, the size and shape of the nozzle assembly 700c facilitates and helps maintain a consistent operating pressure throughout the system 1000.

The valve body 702, as shown, defines one or more flow passages 720 in fluid communication between the fluid inlet (through connector 710) and one or more fluid outlets 725. The flow passages 720 are converging toward the fluid outlets 725. In other words, the cross-sectional area of the flow passages 720 is decreasing as the fluid flows toward the outlets 725. The converging shape of the flow passages 720 may be formed by any of a variety of nozzle elements and commercially available designs. The converging shape of the flow passages 720 causes a rapid increase in flow velocity and a rapid decrease in pressure. The rapid pressure drop causes at least a portion of the gas nanobubbles to be released into the fluid in the reservoir 10. The gas nanobubbles that were once dissolved in the second solution, as they pass through the converging nozzle assembly 700c, are released from the second solution and injected into the fluid in the reservoir 10. This release of gas facilitates the destruction of pollutants and other contaminants in the fluid. For implementations in which the gas is an ozone-rich gas and the fluid is contaminated water, the release of nanobubbles creates hydroxyl radicals which are highly reactive and useful in destroying organic compounds and other contaminants in water.

Applications of the methods and systems described herein are useful for disinfecting bodies of water, such as lakes, wetlands, livestock waste pits, ballast water in watercraft, and wastewater ponds or tanks. Applications of the methods and systems described herein are useful for disinfecting the air in a room or other bounded space, including the surfaces, equipment, and other items in the room; for disinfecting medical equipment instead of or in addition to autoclaving; and for sterilizing fruits, vegetables, and other perishable foods.

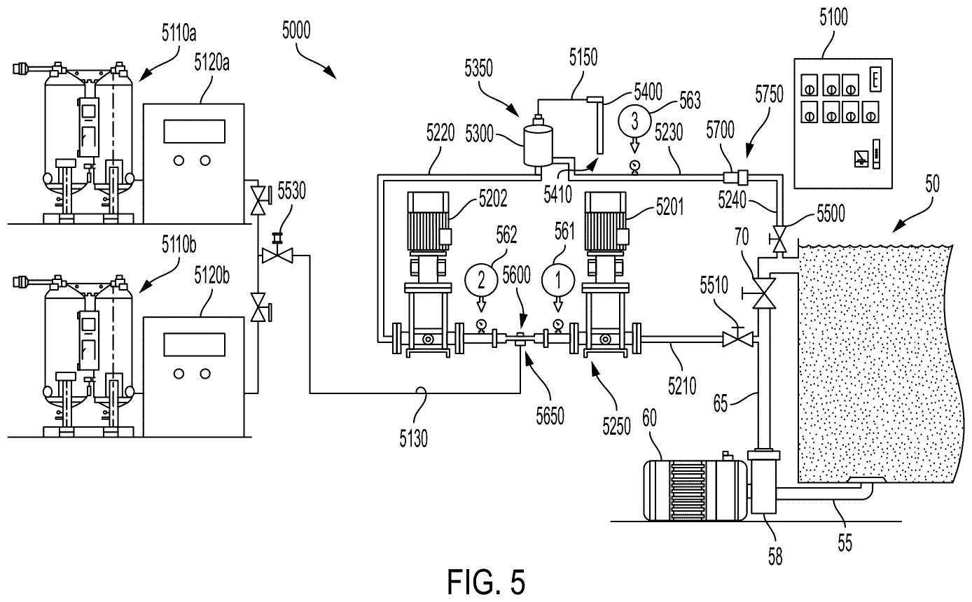

FIG. 5 is a schematic illustration of a water treatment system 5000, according to an example implementation. The example system 5000 includes a pump 60 for moving a volume of water from pool 50, through a filter 58, and back into the pool 50. The pool 50 in some example implementations is an open body of water such as a swimming pool, a pond, or a lake, as opposed to a contained volume of water in a tank or other container. The pump 60 in some implementations is an existing, standard pool pump having a capacity appropriate for a particular pool. In other implementations, the pump 60 is a new pump, installed as part of the water treatment systems described herein.

Although some example implementations are described with reference to a swimming pool, the systems and methods described herein may be applied to and used with any reservoir, tank, or other body of water, and for a variety of applications including pond remediation, disinfecting tanks, and waste water treatment.

The example water treatment system 5000 in some implementations includes a control valve 5510 located downstream relative to the pump 60. The control valve 5510 in some implementations is monitored, adjusted, and controlled by a control unit 5100, so that the control valve 5510 circulates a select volume of water into and through a circuit of elements, wherein each element is in fluid communication with adjacent elements, as shown. The control valve 5510 in some implementations is adjusted to fully open so that the entire flow of water that passes through the pump 60 and the filter 58 is diverted into and through the circuit of elements.

The control unit 5100 in some implementations houses variable frequence drive (VFD) motors, contactors, breakers, control wiring, and other components for monitoring, adjusting, and controlling the operating parameters of the circuit of elements. The control unit 5100 in some implementations includes remote access, logging of temperatures and pressures, an automatic timer, pressure sensors, a run-time clock, a high-pressure shutoff assembly, a low-pressure shutoff assembly, automatic alarms including text alerts, geolocation data, and operational status reports including power status.

The circuit of elements in this example implementation includes a pump assembly 5250, a Venturi assembly 5650, a pressure vessel assembly 5350, a nozzle assembly 5750, and a backflow valve 5500.

The pump assembly 5250 in this example implementation includes two pumps 5201, 5202. The first pump 5201 is located upstream relative to the Venturi assembly 5650. The second pump 5202 is located downstream relative to the Venturi assembly 5650. The second pump 5202 in some implementations allows the pump assembly 5250 to process three to five times more water than the first pump 5201 alone. In another aspect, the second pump 5202 in some implementations cooperates with the pressure vessel assembly 5350 and the nozzle assembly 5750 to produce a high concentration of ozone-filled nanobubbles.

The pumps 5201, 5202 in some implementations are multi-stage pumps designed to increase pressure and drive the volume of water through the circuit of elements. In some implementations, the control unit 5100 monitors, adjusts, and otherwise controls the two pumps 5201, 5202, in coordination with the main pump 60, to optimize the flow of water through the circuit of elements. For example, the control unit 5100 might adjust the pump 60 to run at 100%, the first pump 5201 at 80%, and the second pump 5202 at 60%.

The Venturi assembly 5650 in this example implementation includes an entry pressure gauge 561, a Venturi injector 5600, and an exit pressure gauge 562. The Venturi injector 5600 is in fluid communication with a gas supply which, in some implementations, includes one or more oxygen concentrators 5110a, 5110b for converting ambient air into an oxygen-enriched gas. Some types of oxygen concentrators can process about thirty liters per minute and generate an oxygen enrichment of about ninety-two percent. Larger concentrators and other equipment can be used to scale the system to handle larger or smaller volumes of fluids and gases. The gas supply in some implementations includes one or more ozone generators 5120a, 5120b for converting the oxygen-enriched gas into an ozone-rich gas. The gas supply in some implementations includes one or more devices in a supply group that includes an oxygen concentrator, an ozone generator, and an ozone supply (e.g., tanks filled with ozone).

The ozone-rich gas enters the circuit of elements at the Venturi injector 5600. As shown, the gas supply is in fluid communication with the Venturi injector 5600 through a gas inlet tube 5130 and may be controlled by a gas control valve 5530.

In some implementations, the control valve 5510 is partly or fully open, allowing the volume of water to flow through the Venturi injector 5600 and create a vacuum, drawing in the ozone-rich gas where it dissolves into the water. In other implementations, the control valve 5510 is partly or fully closed, and the ozone-rich gas is supplied at a relatively high pressure, thereby increasing the amount of ozone-rich gas that gets dissolved into the water.

The Venturi injector 5600 is sized and shaped to create the Venturi effect as a fluid flows through it. The Venturi injector 5600 includes a suction port in the side wall of the lengthwise chamber through which the fluid flows. In some implementations, a gas inlet tube 5130 carrying ozone-rich gas is connected to the suction port. The gas inlet tube 5130, in some implementations, does not include a control valve, instead relying on the suction generated by the Venturi injector 5600 to draw in the ozone-rich gas. The lengthwise chamber of the Venturi injector 5600 is sized and shaped to create a pressure differential, which is sufficient to draw in gas through the suction port and into the select volume of water.

The suction created by the pressure differential across the Venturi injector 5600 helps dissolve a variable quantity of the ozone-rich gas into the select volume of water. In some implementations, the control unit 5100 monitors, adjusts, and otherwise controls the operating parameters associated with the circuit of elements, so that the Venturi injector 5600 dissolves a target quantity of the ozone-rich gas into the select volume of water. The target quantity varies, depending on the size of the system and the number and types of components included in the circuit of elements.

In the example implementation, the pressure differential across the Venturi injector 5600 is monitored by an entry pressure gauge 561 and an exit pressure gauge 562. As shown, the entry pressure gauge 561 is located upstream relative to the Venturi injector 5600. The exit pressure gauge 562 is located downstream relative to the Venturi injector 5600. The pressure gauges 561, 562 provide information about the pressure differential to the control unit 5100, which monitors, adjusts, and otherwise controls the operating parameters associated with the circuit of elements to achieve a desired pressure differential. In this aspect, the pressure gauges 561, 562 are useful to optimize the amount of ozone-rich gas that gets dissolved into the volume of water.

The pressure vessel assembly 5350 in this example implementation includes a pressure vessel 5300, a vapor tube 5150, and an ozone destructor 5400. Instead of releasing excess ozone-rich gas into the atmosphere, the excess gas travels through the vapor tube 5150 and into the ozone destructor 5400, as shown. The ozone destructor 5400 in some implementations includes a catalyst for converting most of the excess ozone gas into oxygen, which is released to the atmosphere through an outlet 5410.

As shown, the pressure vessel assembly 5350 receives a flow of the select volume of water from the second pump 5202 through a connecting pipe 5220. The pressure vessel 5350 is sized, shaped, and otherwise designed to retain a portion of the select volume of water under a design internal pressure and for a design duration. The pressure vessel 5350 is designed to buffer the water and allow the injected ozone-rich gas time to dissolve more fully into the water. In some implementations, the design internal pressure is a predetermined value established during the design phase of a particular system. The design internal pressure setting may be adjustable, depending on operating conditions. In some implementations the control unit 5100 monitors, adjusts, and otherwise controls the operating parameters associated with the circuit of elements to achieve a desired internal pressure inside the pressure vessel 5350. Similarly, in some implementations, the design duration is a predetermined value established during the design phase of a particular system. The design duration setting may be adjustable, depending on operating conditions. In some implementations the control unit 5100 monitors, adjusts, and otherwise controls the operating parameters associated with the circuit of elements to achieve a desired duration for the portion of the select volume of water to remain inside the pressure vessel 5350.

An example pressure vessel 300 suitable for use with the example systems and methods described herein is shown in FIG. 2A. The example pressure vessel 300 receives the flow water through a connecting pipe 215 (e.g., the connecting pipe 5220 in FIG. 5). Near the base of the pressure vessel 300, the incoming water flows through a diverter pipe 310, as shown in FIG. 2A. The diverter pipe 310 extends lengthwise from a base end at the base of the pressure vessel 300 to a distal end. The distal end of the diverter pipe 310 may be located near the center of the pressure vessel 300, or at another location, to facilitate mixing. As shown, the side wall of the diverter pipe 310 includes a plurality of perforations 315. The flow of water exits the pipe 310 through the perforations 315 and into the pressure vessel 300. The perforations 315 may be any of a variety of sizes and shapes designed to facilitate mixing and injection. The example pressure vessel 300 includes a vent 330 near the top. In some implementations, the pressure vessel 300 includes a deflector 320. The deflector 320 is sized and shaped, and positioned, to selectively inhibit the incoming flow of water from flowing into the vent 330. In this aspect, the deflector 320 prevents the incoming water from spraying or otherwise flowing into the vent 330, which is designed to capture excess gas and not fluid. The deflector 320 is also sized and shaped, and positioned, to selectively inhibit the flow of ozone-rich gas from entering the vent 330 too soon. FIG. 2B is a perspective illustration of an example deflector 320, which in some implementations is made from a metal plate, one-eighth inch thick and generally rectangular in shape. The example deflector 320 is a curved plate with its four corners attached to the ceiling or upper inner surfaces inside the pressure vessel 300 near the vent 330. The excess flow of ozone-rich gas, in this example, may flow around the side edges of the example deflector 320 and into the vent 330. The deflector 320, in some implementations, may be made from another material, formed into other shapes and sizes, and may include perforations or other openings to allow the excess flow of ozone-rich gas to enter the vent 330. The design internal pressure inside the pressure vessel 300 is designed, monitored, adjusted and otherwise controlled in order to facilitate mixing of the water and to promote additional injection or dissolution of ozone-rich gas into the water. In general, when the design internal pressure is exceeded, the excess flow of ozone-rich gas will enter the vent 330.

The nozzle assembly 5750 in this example implementation is located downstream relative to the pressure vessel assembly 5350. The nozzle assembly 5750 includes a nozzle 5700 and a nozzle pressure gauge 563. The nozzle 5700 is sized and shaped to generate a variable concentration of ozone-filled nanobubbles in the select volume of water

In some implementations, all or most of the select volume of water is directed into and through the nozzle 570. In some implementations, the nozzle assembly 5750 includes a single nozzle 5700. In some implementations, the nozzle assembly 5750 includes two or more nozzles 5700, either positioned in a series in the pipe 5230 or in parallel in separate pipes.

An example nozzle that is suitable for use with the example systems and methods described herein is shown in FIG. 4. The example nozzle assembly 700c includes a threaded connector 710 configured to attach to a pipe. In some implementations, the nozzle assembly 700c generates a backflow pressure into the circuit of elements, which facilitates the additional dissolution of ozone-rich gas and the injection of nanobubbles into the select volume of water. The example valve body 702, as shown, defines one or more flow passages 720 in fluid communication between the fluid inlet (through connector 710) and one or more fluid outlets 725. The example flow passages 720 are converging toward the fluid outlets 725. In other words, the cross-sectional area of the flow passages 720 is decreasing as the fluid flows toward the outlets 725. The converging shape of the flow passages 720 may be formed by any of a variety of nozzle elements. The converging shape of the flow passages 720 causes a rapid increase in flow velocity and a rapid decrease in pressure.

The rapid pressure drop across and through the nozzle 5700 causes the ozone-rich gas dissolved in the volume of water to escape from the water and, in effect, to be converted into ozone-filled nanobubbles. As shown in FIG. 5, the nozzle assembly 5750 may be located relatively close to the pipe through which the treated volume of water enters the pool 50. When the ozone-filled nanobubbles are released into the pool, the nanobubbles create hydroxyl radicals which are highly reactive and useful in destroying organic compounds and other contaminants which may be present in the pool water.

In the example implementation shown in FIG. 5, the pressure near the nozzle assembly 5750 is monitored by a nozzle pressure gauge 563 located upstream relative to the nozzle 5700. The nozzle pressure gauge 563 provides information about the pressure near the nozzle to the control unit 5100, which monitors, adjusts, and otherwise controls the operating parameters associated with the circuit of elements to achieve a desired pressure near the nozzle 5700. In this aspect, the nozzle pressure gauge 563 is useful to optimize the amount of concentration of ozone-filled nanobubbles that are generated in the volume of water.

The backflow valve 5500 in this example implementation is located downstream relative to the nozzle assembly 5750. The backflow valve 5500 can be adjusted to selectively generate a backflow pressure in the volume of water. A change in the backflow pressure generated by the backflow valve 500 in some implementations causes a change in the pressure at the nozzle assembly 5750 (as sensed by the nozzle pressure gauge 563) and in the internal pressure inside the pressure vessel 5300. In some implementations, the control unit 5100 monitors, adjusts, and otherwise controls the backflow valve 5500 (and therefore, the backflow pressure) to optimize the operating parameters associated with the circuit of elements.

In another aspect, the backflow valve 500 in some implementations controls the delivery of the treated water, including the ozone-filled nanobubbles made by the nozzle 5700, back into the pool 50. In operation, the ozone-filled nanobubbles generate hydroxyl radicals in the pool water, which are highly reactive and useful in destroying organic compounds and other contaminants.

The control unit 5100 in some implementations selectively controls the circuit of elements until a condition is satisfied. Using sensors and measurements, the condition to be satisfied in some implementations includes one or more conditions in a condition group: (1) a target quantity of the ozone-rich gas is dissolved into the select volume of water by the Venturi injector, (2) a target concentration of ozone-filled nanobubbles is generated in the select volume of water by the nozzle, and (3) a target net concentration of dissolved ozone is measured in the water in the pool. In this aspect, the water treatment systems described herein include a sensor, test kit, or other devices for measuring the concentration of dissolved ozone in the water in the pool. The target net concentration means and includes periodic readings as well as average readings over time and may include multiple readings at various locations in the pool and throughout the system.

In some implementations, the example water treatment system 5000 illustrated in FIG. 5 includes one or more elements that cooperate to satisfy a condition, meet a design parameter, or otherwise produce a desired result. For example, in some implementations, the pump assembly 5250 and the Venturi assembly 5650 cooperate to dissolve a target quantity of the ozone-rich gas into the select volume of water. In some implementations, the pump assembly 5250 and the nozzle assembly 5750 cooperate to generate a target concentration of ozone-filled nanobubbles in the select volume of water. In operation, the control unit 5100 makes adjustments to a variety of settings associated with one or more elements in the circuit of elements in order to meet or approach the target quantity of dissolved ozone-rich gas and the target concentration of ozone-filled nanobubbles. The target quantity and the target concentration may be adjusted in order to meet or approach a target net concentration of dissolved ozone (e.g., including periodic readings and average readings over time) as measured in the water in the pool.

The control unit 5100 in some implementations controls one or more operating parameters associated with the circuit of elements to satisfy a condition, meet a design parameter, or otherwise produce a desired result. The operating parameters in some implementations include one or more of the following parameters in a parameter group: (1) a valve setting associated with the control valve for circulating the select volume of water in and through the circuit of elements; (2) a pool pump setting associated with the pump for generating a target pressure differential across the Venturi injector; (3) a setting associated with the pump assembly for generating a target pressure differential across the Venturi injector, such that the target quantity of ozone-rich gas is dissolved into the water at the Venturi injector; (4) a gas pressure associated with the gas supply for generating the target quantity of ozone-rich gas dissolved into the water at the Venturi injector; (5) a second setting associated with the pump assembly for generating a target nozzle pressure associated with the nozzle assembly, such that the target concentration of ozone-filled nanobubbles generated by the nozzle assembly; (6) a backflow valve setting for generating a target backflow pressure in the volume of water upstream relative to the backflow valve; and (7) a second backflow valve setting for generating a target internal pressure and a target duration associated with the pressure vessel assembly.

The example system 5000 illustrated in FIG. 5 in some implementations would be useful for relatively large, commercial pools, such as pools used for recreation, competitive swimming and other sports, and for other relatively large bodies of water.

The processes and the circuit of elements described herein produce a stable concentration of ozone-filled nanobubbles in the volume of water that is returned to the pool. Compared to systems that include only ozone dissolved in the water, the stable concentration of ozone-filled nanobubbles extends the half-life and prolongs the usefulness of ozone in the water. Sample measurements of dissolved ozone range from 0.025 to 0.075 mgO3/L (milligrams of ozone per liter). Some experts recommend an optimal concentration of dissolved ozone in the range of 0.03 to 0.07 mgO3/L. In operation, the net concentration of ozone-filled nanobubbles in the pool water is remarkably stable, allowing the dissolved ozone levels to remain steady in the water column for relatively long periods of time.

Ozone-filled nanobubbles are thousands of times more effective than chlorine for disinfecting water, eliminating a wider range of contaminants including bacteria, viruses, algae, microorganisms, organic compounds, and inorganic contaminants. Compared to some chemicals, ozone-filled nanobubbles have a relatively large surface area that facilitates greater contact between the ozone and the impurities in the water.

Ozone-filled nanobubbles are odorless and safe for swimmers and bathers, unlike chlorine which forms irritating chloramines and potentially harmful trihalomethanes (THMs) in the water. Ozone is a naturally occurring gas that breaks down into oxygen over time, making it more environmentally friendly compared to chlorine and other pool chemicals. Ozone-filled nanobubbles noticeably improve the clarity of pool water compared to untreated or chlorine-treated water.

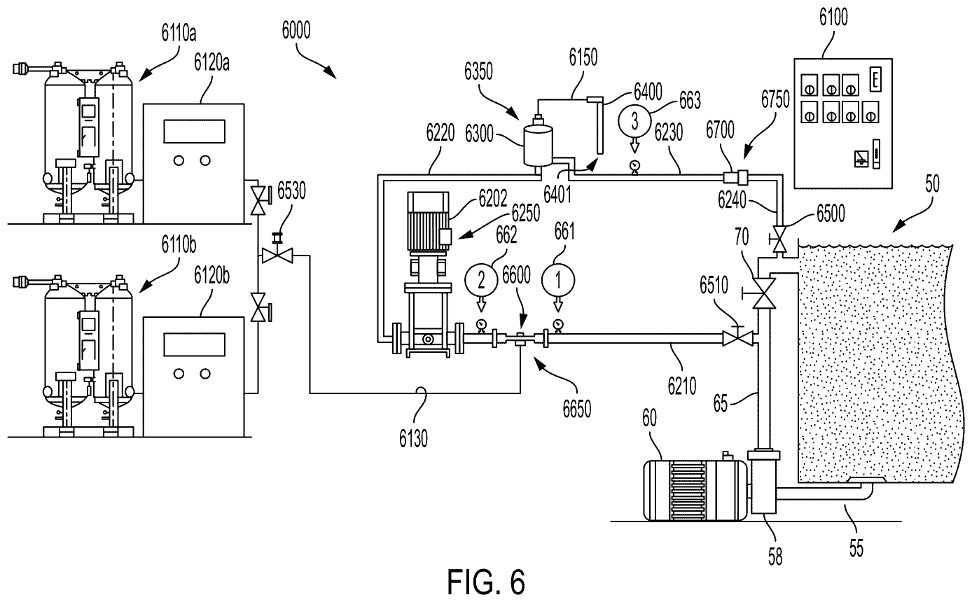

FIG. 6 is a schematic illustration of a water treatment system 6000, according to another example implementation. This example water treatment system 6000 is similar in structure and function to the example system 5000 shown in FIG. 5, except the pump assembly 6250 includes a single pump 6202. In general, the system 6000 with a single pump 6202 operates at a lower cost and energy usage, compared to the example two-pump system 5000 shown in FIG. 5. The elements in FIG. 6 are labeled with element numbers that are similar to the numbers used in FIG. 5. For example, the suffix -250 is used for the pump assembly (e.g., the pump assembly 6250 in FIG. 6 and the pump assembly 5250 in FIG. 5).

The example system 6000 illustrated in FIG. 6 in some implementations would be useful for medium-sized and relatively small commercial pools, such as pools used for recreation, competitive swimming and other sports; and for large residential pools.

In some implementations, the control valve 6510 is partly or fully open, allowing the entire volume of water to flow into and through the Venturi assembly 6650. The pump 60 in some implementations generates a sufficient flow and creates a pressure differential across and through the Venturi injector 6600 that is necessary to dissolve the ozone-rich gas into the water. The single multi-stage pump 6202 creates a pressure at the nozzle assembly 6750 that is sufficient to generate a relatively high concentration of ozone-filled nanobubbles.

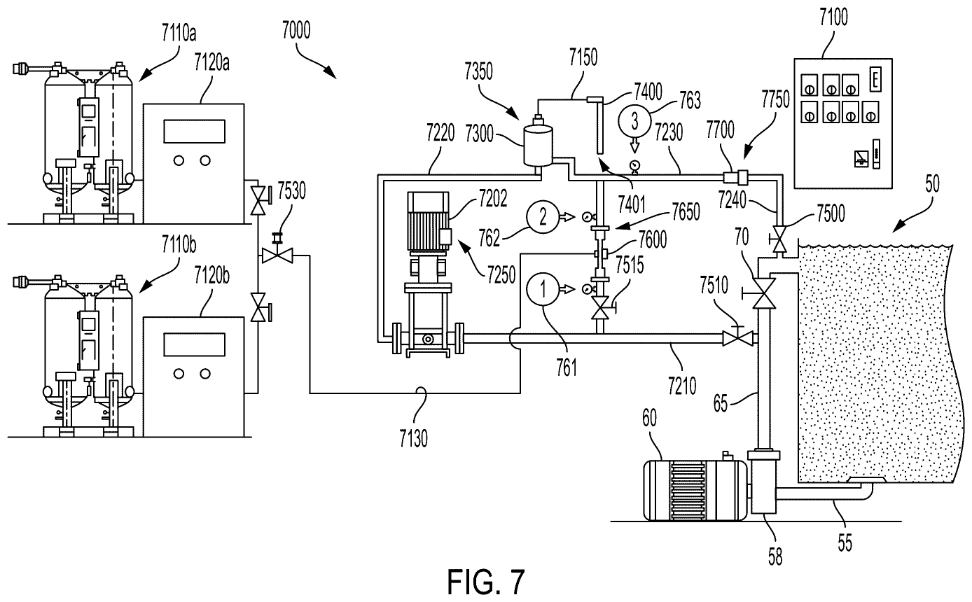

FIG. 7 is a schematic illustration of a water treatment system 7000, according to another example implementation. This example water treatment system 7000 is similar in structure and function to the example system 6000 shown in FIG. 6, except the Venturi assembly 7650 is located in a bypass pipe that runs from the inlet pipe 7210 near the control valve 7510 to the pipe 7230 near the nozzle assembly 7750. The elements in FIG. 7 are labeled with element numbers that are similar to the numbers used in FIG. 5 and FIG. 6. For example, the suffix -250 is used for the pump assembly (e.g., the pump assembly 7250 in FIG. 7, the pump assembly 6250 in FIG. 6, and the pump assembly 5250 in FIG. 5).

As shown in FIG. 6, the Venturi assembly 7650 is located in a bypass pipe that runs from the inlet pipe 7210 near the control valve 7510 to the pipe 7230 near the nozzle assembly 7750. In some implementations, a valve 7515 diverts a portion of the volume of water into the bypass pipe and through the Venturi assembly 7650. The diverted portion of water does not pass through the pump assembly 7250 or the pressure vessel assembly 7350. The diverted portion of water is driven primarily by the pump 60. The backflow valve 7500 generates a backflow pressure in the nozzle assembly 7750 and, to some extent, in the Venturi assembly 7650. In this example implementation, the other portion of the volume of water flows into and through the pump assembly 7250 and the pressure vessel assembly 7350 before reaching the nozzle assembly 7750.

The Venturi assembly 7650 in some implementations does not include the entry pressure gauge 661 and the exit pressure gauge 762. Instead, the nozzle pressure gauge 763 provides sufficient pressure data to allow the control unit 7100 to adjust and control the various parameters associated with the circuit of elements.

In this example implementation, the control valve 7510 is partly open so that only a fraction of the volume of water flows into and through the Venturi assembly 7650. The single multi-stage pump 7202 creates a pressure at the nozzle assembly 7750 that is sufficient to generate a relatively high concentration of ozone-filled nanobubbles. In some implementations, compared to the example system 6000 shown in FIG. 6, the example system 7000 generates a relatively lower concentration of ozone-filled nanobubbles, and a relatively higher quantity of dissolved ozone in the volume of water.

Although several implementations and embodiments have been described herein, those of ordinary skill in art, with the benefit of the teachings of this disclosure, will understand and comprehend many other embodiments and modifications for this technology. This disclosure is not limited to the specific embodiments disclosed or discussed herein, and that may other embodiments and modifications are intended to be included within the scope of the description. Moreover, although specific terms are occasionally used herein, such terms are used in a generic and descriptive sense only and should not be construed as limiting the systems and methods described.

What is claimed is:

1. A water treatment system comprising:
a pump for moving a volume of water from a pool, through a filter, and back to the pool;
a control valve located downstream relative to the pump for selectively circulating a select volume of water through a circuit of elements, wherein the circuit of elements comprises:
a pump assembly for circulating the select volume of water through the circuit of elements;
a Venturi assembly comprising a Venturi injector in fluid communication with a gas supply that generates an ozone-rich gas, wherein the Venturi injector is sized and shaped to dissolve a variable quantity of the ozone-rich gas into the select volume of water;
a pressure vessel assembly comprising a pressure vessel sized and shaped to retain a portion of the select volume of water under a design internal pressure and for a design duration;
a nozzle assembly comprising a nozzle located downstream relative to the pressure vessel, wherein the nozzle is sized and shaped to generate a variable concentration of ozone-filled nanobubbles in the select volume of water; and
a backflow valve located downstream relative to the nozzle for selectively generating a backflow pressure in the select volume of water,
wherein the system further comprises a control unit for selectively controlling the circuit of elements until a condition is satisfied, wherein the condition is selected from a condition group consisting of:
a target quantity of the ozone-rich gas is dissolved into the select volume of water by the Venturi injector;
a target concentration of ozone-filled nanobubbles is generated in the select volume of water by the nozzle; and
a target net concentration of dissolved ozone is measured in the water in the pool.

2. The system of claim 1, wherein the pump assembly and the Venturi assembly cooperate to dissolve a target quantity of the ozone-rich gas into the select volume of water, and
wherein the pump assembly and the nozzle assembly cooperate to generate a target concentration of ozone-filled nanobubbles in the select volume of water.

3. The system of claim 1, wherein control unit selectively controls one or more operating parameters associated with the circuit of elements, wherein the operating parameters are selected from a parameter group consisting of:
a valve setting associated with the control valve for circulating the select volume of water in and through the circuit of elements,
a pool pump setting associated with the pump for generating a target pressure differential across the Venturi injector,
a setting associated with the pump assembly for generating a target pressure differential across the Venturi injector, such that the target quantity of ozone-rich gas is dissolved into the water at the Venturi injector,
a gas pressure associated with the gas supply for generating the target quantity of ozone-rich gas dissolved into the water at the Venturi injector,
a second setting associated with the pump assembly for generating a target nozzle pressure associated with the nozzle assembly, such that the target concentration of ozone-filled nanobubbles generated by the nozzle assembly,
a backflow valve setting for generating a target backflow pressure in the volume of water upstream relative to the backflow valve, and
a second backflow valve setting for generating a target internal pressure and a target duration associated with the pressure vessel assembly.

4. The system of claim 1, wherein the pump assembly comprises a first pump located upstream relative to the Venturi assembly and a second pump located downstream relative to the Venturi assembly.

5. The system of claim 1, wherein the pump assembly comprises a single pump located downstream relative to the Venturi assembly.

6. The system of claim 1, wherein the Venturi assembly comprises an entry pressure gauge located upstream relative to the Venturi injector and an exit pressure gauge located downstream relative to the Venturi injector, such that the pressure gauges cooperate to estimate a pressure differential across the Venturi injector.

7. The system of claim 1, wherein the gas supply comprises at least one device selected from a supply group consisting of:
an oxygen concentrator for converting ambient air into an oxygen-enriched gas;
an ozone generator for receiving and converting at least a portion of the oxygen-enriched gas into an ozone-rich gas;
an ozone generator for generating a supply of ozone-rich gas; and
an ozone supply.

8. The system of claim 1, wherein the pressure vessel comprises:
a diverter pipe wall defining a chamber extending lengthwise inside the pressure vessel from a base end to a distal end, wherein the chamber is in fluid communication with the pressure vessel and with a connecting pipe, and wherein the diverter pipe wall further defines a plurality of perforations therethrough;
a vent positioned to release an excess volume of ozone-rich gas from the water inside the pressure vessel; and
a deflector that is sized and shaped and positioned to selectively inhibit the water from flowing into the vent, such that the deflector selectively prolongs the design duration during which the water remains inside the pressure vessel.

9. The system of claim 1, wherein the nozzle assembly comprises a nozzle pressure gauge located upstream relative to the nozzle, and wherein the nozzle comprises:
a nozzle body defining a flow passage and an outlet, wherein the flow passage is shaped to converge in size toward the outlet, such that the converging shape facilitates the generation of ozone-filled nanobubbles in the volume of water.

10. The system of claim 1, wherein the backflow valve controls the delivery of the ozone-filled nanobubbles into the pool, and
wherein the ozone-filled nanobubbles generate hydroxyl radicals that facilitate removal of contaminants from the pool.

11. A method of treating water, comprising:
moving a volume of water from a pool, through a filter, and back to the pool, using a pump;
adjusting a control valve located downstream relative to the pump such that a select volume of water is circulated through a circuit of elements, wherein the circuit of elements comprises:
a pump assembly for circulating the select volume of water through the circuit of elements;
a Venturi assembly comprising a Venturi injector in fluid communication with a gas supply that generates an ozone-rich gas, wherein the Venturi injector is sized and shaped to dissolve a variable quantity of the ozone-rich gas into the select volume of water;
a pressure vessel assembly comprising a pressure vessel sized and shaped to retain a portion of the select volume of water under a design internal pressure and for a design duration;
a nozzle assembly comprising a nozzle located downstream relative to the pressure vessel, wherein the nozzle is sized and shaped to generate a variable concentration of ozone-filled nanobubbles in the select volume of water; and
a backflow valve located downstream relative to the nozzle for selectively generating a backflow pressure in the select volume of water,
wherein the method comprises selectively controlling the circuit of elements using a control unit until a condition is satisfied, wherein the condition is selected from a condition group consisting of:
a target quantity of the ozone-rich gas is dissolved into the select volume of water by the Venturi injector;
a target concentration of ozone-filled nanobubbles is generated in the select volume of water by the nozzle; and
a target net concentration of dissolved ozone is measured in the water in the pool.

12. The method of claim 11, comprising:
adjusting one or more settings associated with the pump assembly and the Venturi assembly, such that the settings cooperate to dissolve a target quantity of the ozone-rich gas into the select volume of water;
adjusting one or more settings associated with the pump assembly and the nozzle assembly, such that the settings cooperate to generate a target concentration of ozone-filled nanobubbles in the select volume of water.

13. The method of claim 11, comprising:
selectively controlling, using the control unit, one or more operating parameters associated with the circuit of elements, wherein the operating parameters are selected from a parameter group consisting of:
a valve setting associated with the control valve for circulating the select volume of water in and through the circuit of elements,
a pool pump setting associated with the pump for generating a target pressure differential across the Venturi injector,
a setting associated with the pump assembly for generating a target pressure differential across the Venturi injector, such that the target quantity of ozone-rich gas is dissolved into the water at the Venturi injector,
a gas pressure associated with the gas supply for generating the target quantity of ozone-rich gas dissolved into the water at the Venturi injector,
a second setting associated with the pump assembly for generating a target nozzle pressure associated with the nozzle assembly, such that the target concentration of ozone-filled nanobubbles generated by the nozzle assembly,
a backflow valve setting for generating a target backflow pressure in the volume of water upstream relative to the backflow valve, and
a second backflow valve setting for generating a target internal pressure and a target duration associated with the pressure vessel assembly.

14. The method of claim 11, comprising:
installing a first pump located upstream relative to the Venturi assembly and a second pump located downstream relative to the Venturi assembly, such that the pump assembly includes the first pump and the second pump.

15. The method of claim 11, comprising:
installing a single pump located downstream relative to the Venturi assembly, such that the pump assembly includes the single pump.

16. The method of claim 11, comprising:
installing an entry pressure gauge located upstream relative to the Venturi injector and an exit pressure gauge located downstream relative to the Venturi injector, such that the pressure gauges cooperate to estimate a pressure differential across the Venturi injector.

17. The method of claim 11, comprising:
converting ambient air into an oxygen-enriched gas using an oxygen concentrator;
converting at least a portion of the oxygen-enriched gas into an ozone-rich gas using an ozone generator;
generating a supply of ozone-rich gas using at the ozone generator.

18. The method of claim 11, comprising:
receiving a portion of the select volume of water into the pressure vessel through a diverter pipe wall defining a chamber, wherein the chamber extends lengthwise inside the pressure vessel from a base end to a distal end, and wherein the diverter pipe wall further defines a plurality of perforations therethrough;
selectively inhibiting the volume of water from entering a gas vent using a deflector, wherein the deflector is sized and shaped and positioned to selectively prolong the design duration during which the water remains inside the pressure vessel.

19. The method of claim 11, comprising:
installing a nozzle pressure gauge located upstream relative to the nozzle, wherein the nozzle comprises a nozzle body defining a flow passage and an outlet; and
shaping the flow passage to converge in size toward the outlet, such that the converging shape facilitates the generation of ozone-filled nanobubbles in the volume of water.

20. The method of claim 11, comprising:
controlling delivery of the ozone-filled nanobubbles into the pool using the backflow valve, such that the ozone-filled nanobubbles generate hydroxyl radicals for removing contaminants from the pool.
